(19) United States
(12) Patent Application Publication
(10) Pub. No.: US 2020/0300258 A1
(43) Pub. Date: Sep. 24, 2020

(54) AXIAL-FLOW BLOWER EMPLOYING MOTOR SPEED CONTROL

(71) Applicant: Yuyao Feite Plastic Co. Ltd., Yuyao City (CN)

(72) Inventor: Chaoqiang Zhou, Hunan (CN)

(21) Appl. No.: 16/761,056

(22) PCT Filed: Apr. 12, 2019
(86) PCT No.: PCT/CN2019/082517

§ 371 Date: May 1, 2020

(30) Foreign Application Priority Data
Jun. 13, 2018 (CN) 201810607607.4

(51) Int. Cl. F04D 27/00; G06K 9/62; G06F 30/32; F04D 25/08

(52) U.S. Cl. CPC F04D 27/004; G06K 9/6202; G06F 2115/02; F04D 25/08; G06F 30/32

(57) ABSTRACT

An axial-flow blow dryer based on motor speed regulation includes: a motor speed regulation device provided for users to select air volume and hot air temperature; a current capture device for executing a panoramic shooting of the blow dryer; an authorization verification device for executing a characteristic matching of an image characteristic of a self-regulation enhanced image based on a predetermined authorized person's face characteristic. If the characteristic matching has a percentage value exceeding a predetermined percentage threshold, then an authorized person existence signal will be issued; a motor driving device for stopping the response of the motor speed regulation device to its various operations when receiving the authorized person non-existence signal, so that the present invention can prevent any unauthorized use of the blow dryer effectively.

### FIELD OF INVENTION

The present invention relates to the field of motor control, in particular to an axial-flow blow dryer based on motor speed regulation.

### BACKGROUND OF INVENTION

### Description of the Related Art

Axial-flow blow dryer has a wide scope of applicability, and it is an air-flow blower with air flowing in the same direction of its vanes, which is similar to an electric fan or an external fan of an air-conditioner. It is called “axial-flow” blow dryer because the air flows in a direction parallel to the shaft of the blow dryer. The axial-flow blow dryer is generally used in applications where the flow requirement is high and the pressure requirement is low. The axial-flow blow dryer is fixed to a position to move air, and it is mainly composed of a fan propeller and a housing, and its structure is simple, but the data requirement is high.

### SUMMARY OF THE INVENTION

To overcome the drawback of the conventional blow dryer incapable of limiting the use of the blow dryer by an unauthorized person, the present invention provides an axial-flow blow dryer based on motor speed regulation that can stop a motor speed regulation device of the blow dryer from responding to different operations during an unauthorized use, so as to prevent any unauthorized use of the blow dryer.

To achieve this effect, this invention confirms the criticality of the area according to the quantity of edge points falling into different areas to determine the level of increased contrast, and a multiple of parameters of the image are used at the same time to correct the binarization threshold of the image, so as to ensure the precision of the binarized image so obtained. By a custom analysis of the image, a processing strategy of the image is driven and it includes starting a median filtering operation of the image to substitute the output of the image by the filtered image when the blocking is not confirmed. When the blocking is confirmed, the blocking alarm signal is transmitted to a remote management server via a wireless transmission to facilitate taking a remote control measure and overcome the blocking problem at site, so as to overcome the aforementioned technical issues.

According to an aspect of the present invention, the invention provides an axial-flow blow dryer based on motor speed regulation, comprising: a motor speed regulation device, installed onto a housing of the blow dryer, and provided for users to select an air volume of wind and a hot air temperature; a current capture device, for performing a panoramic shooting of an environment of the blow dryer to obtain and output a corresponding instant captured image; a multi-parameter analysis device, coupled to the current capture device, for receiving the instant captured image, confirming a content uniformity of the instant captured image based on the distribution of pixel values of pixel points of the instant captured image, outputting the content uniformity, confirming a content clarity of the instant captured image based on a dynamic distribution range of the pixel values of the pixel points of the instant captured image, outputting the content clarity, receiving the instant captured image, detecting a contrast of the instant captured image, and outputting the contrast; a coefficient fetching device, coupled to the multi-parameter analysis device, for receiving the content uniformity, the content clarity and the contrast, confirming an influence coefficient of the binarization threshold based on the content uniformity, an influence coefficient of the binarization threshold based on the content clarity, an influence coefficient of the binarization threshold based on the contrast, correcting the binarization threshold based on the three types of influence coefficients, and outputting the corrected binarization threshold; a binarization analysis device, coupled to the coefficient fetching device, for receiving the corrected binarization threshold, and executing a binarization analysis of the instant captured image based on the corrected binarization threshold to obtain a binarized image corresponding to the instant captured image; a smoothing device, coupled to the binarization analysis device, for receiving the binarized image, and executing a smoothing process of the binarized image to obtain and output a corresponding smoothed image; an area division device, coupled to the smoothing device, for receiving the smoothed image, recognizing an edge point of the smoothed image to obtain each edge point in the smoothed image, performing an area division of the smoothed image to obtain each area to be processed, confirming the quantity of edge points in each area to be processed, using the area to be processed with a quantity of edge points exceeding a predetermined quantity threshold as an area to be enhanced, and using the area to be processed with a quantity of edge points not exceeding the predetermined quantity threshold as another area; a self-regulation enhancement device, coupled to the area division device, for executing a contrast enhancement process of an area to be enhanced to a corresponding magnitude based on the quantity of internal edge points to obtain an enhanced area, executing a contrast enhancement process of the other area to a corresponding magnitude to obtain another processed area, performing an integration process of each enhanced area and each other processed area to obtain a corresponding self-regulation enhanced image, and outputting the self-regulation enhanced image; an authorization verification device, coupled to the self-regulation enhancement device, for receiving the self-regulation enhanced image, performing a characteristic matching of an image characteristic of the self-regulation enhanced image based on a predetermined authorized person's face characteristic, and issuing an authorized person existence signal if the characteristic matching has a percentage value exceeding a predetermined percentage threshold, or else issuing an authorized person non-existence signal; a motor driving device, coupled to the authorization verification device and the motor speed regulation device, for stopping the motor speed regulation device from responding to different operations thereof when the authorized person non-existence signal is received; wherein, the motor driving device resumes the motor speed regulation device to respond to different operations thereof when the authorized person existence signal is received.

Specifically, the multi-parameter analysis device, the coefficient fetching device and the binarization analysis device are implemented by using different SOC chips respectively.

Specifically, the axial-flow blow dryer based on motor speed regulation further comprises a warning control device, coupled to the current capture device, for receiving the instant captured image, fetching each pixel value of each pixel point in the instant captured image, calculating a standard deviation based on each pixel value of each pixel point in the instant captured image, issuing a blocking warning signal when the standard deviation is over-limit, and issuing a non-blocking prompt signal when the standard deviation is not over-limit.

Specifically, the axial-flow blow dryer based on motor speed regulation further comprises a sub-image composition device, coupled to the warning control device, for fetching each brightness of each pixel point in the instant captured image when the blocking warning signal is received, using the pixel point with the brightness smaller than or equal to a predetermined brightness threshold as a blocked pixel point, eliminating an isolated blocked pixel point in the instant captured image, combining each non-isolated blocked pixel point in the instant captured image to form each blocking sub-image.

Specifically, the axial-flow blow dryer based on motor speed regulation further comprises an alarm control device, coupled to the sub-image composition device, for receiving each blocking sub-image in the instant captured image, calculating a quantity of pixel points occupied by each blocking sub-image as an area corresponding to the blocking sub-image, eliminating the blocking sub-image with an area smaller than or equal to a predetermined area threshold, accumulating each area of each remaining blocking sub-image to obtain a total blocking area, issuing a blocking alarm signal when the total blocking area is over-limit, and issuing an unconfirmed blocking signal when the total blocking area is not over-limit.

Specifically, the axial-flow blow dryer based on motor speed regulation further comprises a decision control device, coupled to the alarm control device, for starting a median filtering operation of the instant captured image when the unconfirmed blocking signal is received, substituting the filtered image by the instant captured image as an output, transmitting the blocking alarm signal to a remote management server via a wireless transmission when the blocking alarm signal is received.

Specifically, the median filtering operation executed in the decision control device uses a filter window size directly proportional to the total blocking area.

### DESCRIPTION OF THE PREFERRED EMBODIMENTS

To make it easier for our examiner to understand the objective of the invention, its structure, innovative features, and performance, we use a preferred embodiment together with the attached drawings for the detailed description of the invention.

The operation of the vanes of the axial-flow blow dryer is similar to an aircraft wing, but the latter exerts an upward lifting force on the aircraft wing to support the weight of the aircraft, and the axial-flow blow dryer is fixed at a position and provided for moving air.

The axial-flow blow dryer generally has a cross-section of a wing profile. The vanes can be fixed to a position or rotated around a longitudinal axis. The angles of the vanes and airflow or the distance between the vanes may be adjustable or non-adjustable. Changing the angle of the vanes or the distance between the vanes is one of the major advantages of the axial-flow blow dryer. Decreasing the distance between the vanes produces a lower flow and increasing the distance between the vanes produces a higher flow.

In view of the aforementioned deficiency, the present invention provides an axial-flow blow dryer based on motor speed regulation to overcome the corresponding issues effectively.

In an embodiment of the present invention, the axial-flow blow dryer based on motor speed regulation comprises:

a motor speed regulation device, installed onto a housing of the blow dryer, and provided for users to select an air volume of wind and a hot air temperature;

a current capture device, for performing a panoramic shooting of an environment of the blow dryer to obtain and output a corresponding instant captured image;

a multi-parameter analysis device, coupled to the current capture device, for receiving the instant captured image, confirming a content uniformity of the instant captured image based on the distribution of pixel values of pixel points of the instant captured image, outputting the content uniformity, confirming a content clarity of the instant captured image based on a dynamic distribution range of the pixel values of the pixel points of the instant captured image, outputting the content clarity, receiving the instant captured image, detecting a contrast of the instant captured image, and outputting the contrast;

a coefficient fetching device, coupled to the multi-parameter analysis device, for receiving the content uniformity, the content clarity and the contrast, confirming an influence coefficient of the binarization threshold based on the content uniformity, an influence coefficient of the binarization threshold based on the content clarity, an influence coefficient of the binarization threshold based on the contrast, correcting the binarization threshold based on the three types of influence coefficients, and outputting the corrected binarization threshold;

a binarization analysis device, coupled to the coefficient fetching device, for receiving the corrected binarization threshold, and executing a binarization analysis of the instant captured image based on the corrected binarization threshold to obtain a binarized image corresponding to the instant captured image;

a smoothing device, coupled to the binarization analysis device, for receiving the binarized image, and executing a smoothing process of the binarized image to obtain and output a corresponding smoothed image;

an area division device, coupled to the smoothing device, for receiving the smoothed image, recognizing an edge point of the smoothed image to obtain each edge point in the smoothed image, performing an area division of the smoothed image to obtain each area to be processed, confirming the quantity of edge points in each area to be processed, using the area to be processed with a quantity of edge points exceeding a predetermined quantity threshold as an area to be enhanced, and using the area to be processed with a quantity of edge points not exceeding the predetermined quantity threshold as another area;

a self-regulation enhancement device, coupled to the area division device, for executing a contrast enhancement process of an area to be enhanced to a corresponding magnitude based on the quantity of internal edge points to obtain an enhanced area, executing a contrast enhancement process of the other area to a corresponding magnitude to obtain another processed area, performing an integration process of each enhanced area and each other processed area to obtain a corresponding self-regulation enhanced image, and outputting the self-regulation enhanced image;

an authorization verification device, coupled to the self-regulation enhancement device, for receiving the self-regulation enhanced image, performing a characteristic matching of an image characteristic of the self-regulation enhanced image based on a predetermined authorized person's face characteristic, and issuing an authorized person existence signal if the characteristic matching has a percentage value exceeding a predetermined percentage threshold, or else issuing an authorized person non-existence signal; and

a motor driving device, coupled to the authorization verification device and the motor speed regulation device, for stopping the motor speed regulation device from responding to different operations thereof when the authorized person non-existence signal is received;

wherein, the motor driving device resumes the motor speed regulation device to respond to different operations thereof when the authorized person existence signal is received.

The specific structure of the axial-flow blow dryer based on motor speed regulation of the present invention is described in details below.

In the axial-flow blow dryer based on motor speed regulation, the multi-parameter analysis device, the coefficient fetching device and the binarization analysis device are implemented by using different SOC chips respectively.

The axial-flow blow dryer based on motor speed regulation further comprises a warning control device, coupled to the current capture device, for receiving the instant captured image, fetching each pixel value of each pixel point in the instant captured image, calculating a standard deviation based on each pixel value of each pixel point in the instant captured image, issuing a blocking warning signal when the standard deviation is over-limit, and issuing a non-blocking prompt signal when the standard deviation is not over-limit.

The axial-flow blow dryer based on motor speed regulation further comprises a sub-image composition device, coupled to the warning control device, for fetching each brightness of each pixel point in the instant captured image when the blocking warning signal is received, using the pixel point with the brightness smaller than or equal to a predetermined brightness threshold as a blocked pixel point, eliminating an isolated blocked pixel point in the instant captured image, combining each non-isolated blocked pixel point in the instant captured image to form each blocking sub-image.

The axial-flow blow dryer based on motor speed regulation further comprises an alarm control device, coupled to the sub-image composition device, for receiving each blocking sub-image in the instant captured image, calculating a quantity of pixel points occupied by each blocking sub-image as an area corresponding to the blocking sub-image, eliminating the blocking sub-image with an area smaller than or equal to a predetermined area threshold, accumulating each area of each remaining blocking sub-image to obtain a total blocking area, issuing a blocking alarm signal when the total blocking area is over-limit, and issuing an unconfirmed blocking signal when the total blocking area is not over-limit.

The axial-flow blow dryer based on motor speed regulation further comprises a decision control device, coupled to the alarm control device, for starting a median filtering operation of the instant captured image when the unconfirmed blocking signal is received, substituting the filtered image by the instant captured image as an output, transmitting the blocking alarm signal to a remote management server via a wireless transmission when the blocking alarm signal is received.

In the axial-flow blow dryer based on motor speed regulation, the median filtering operation executed in the decision control device uses a filter window size directly proportional to the total blocking area.

In addition, SOC stands for System On Chip. In a narrow sense, the SOC is an integrated chip of an information system core which is a major system component integrated onto a chip. Broadly speaking, the SOC is a microsystem. If a central processing unit (CPU) is similar to a human brain, then SOC will be a system including human brain, heart, eyes and hands. Academia general prefers to define SOC as a microprocessor, an analog IP core, a digital IP core and a memory (or an off-chip memory storage control interface) integrated onto a single chip. The SOC is usually a custom-made product or a standard product for specific uses.

The basic content of the SOC definition mainly resides on the following two aspects: its composition and its formation process. A system chip can be composed of a system chip control logic module, a core module of a microprocessor/microcontroller (CPU), a digital signal processing (DSP) module, an embedded memory module, and an external communication interface module, and it includes an analogy front-end module of ADC/DAC, and power supply and power management module. In addition, a wireless SOC further includes a radio frequency front-end module, a user-defined logic (implemented by FPGA or ASIC) and a microelectronic mechanical module. More importantly, a SOC chips is embedded with a basic software (such as RDOS, COS or other application software) module or a loadable user software, etc.

The axial-flow blow dryer based on motor speed regulation of the present invention overcomes the technical issue of the conventional blow dryer incapable of preventing unauthorized use, and stops the motor speed regulation device of the blow dryer from responding to different operations, so as to prevent an unauthorized use of the blow dryer. To achieve this effect, this invention confirms the criticality of the area according to the quantity of edge points falling into different areas to determine the level of increased contrast, and a multiple of parameters of the image are used at the same time to correct the binarization threshold of the image, so as to ensure the precision of the binarized image so obtained. By a custom analysis of the image, a processing strategy of the image is driven and it includes starting a median filtering operation of the image to substitute the output of the image by the filtered image when the blocking is not confirmed. When the blocking is confirmed, the blocking alarm signal is transmitted to a remote management server via a wireless transmission to facilitate taking a remote control measure and overcome the blocking problem at site, so as to overcome the aforementioned technical issues.

While the invention has been described by means of specific embodiments, numerous modifications and variations could be made thereto by those skilled in the art without departing from the scope and spirit of the invention set forth in the claims.

What is claimed is:

1. An axial-flow blow dryer based on motor speed regulation, comprising:
a motor speed regulation device, installed onto a housing of the blow dryer, and provided for users to select an air volume of wind and a hot air temperature;
a current capture device, for performing a panoramic shooting of an environment of the blow dryer to obtain and output a corresponding instant captured image;
a multi-parameter analysis device, coupled to the current capture device, for receiving the instant captured image, confirming a content uniformity of the instant captured image based on the distribution of pixel values of pixel points of the instant captured image, outputting the content uniformity, confirming a content clarity of the instant captured image based on a dynamic distribution range of the pixel values of the pixel points of the instant captured image, outputting the content clarity, receiving the instant captured image, detecting a contrast of the instant captured image, and outputting the contrast;
a coefficient fetching device, coupled to the multi-parameter analysis device, for receiving the content uniformity, the content clarity and the contrast, confirming an influence coefficient of the binarization threshold based on the content uniformity, an influence coefficient of the binarization threshold based on the content clarity, an influence coefficient of the binarization threshold based on the contrast, correcting the binarization threshold based on the three types of influence coefficients, and outputting the corrected binarization threshold;
a binarization analysis device, coupled to the coefficient fetching device, for receiving the corrected binarization threshold, and executing a binarization analysis of the instant captured image based on the corrected binarization threshold to obtain a binarized image corresponding to the instant captured image;
a smoothing device, coupled to the binarization analysis device, for receiving the binarized image, and executing a smoothing process of the binarized image to obtain and output a corresponding smoothed image;
an area division device, coupled to the smoothing device, for receiving the smoothed image, recognizing an edge point of the smoothed image to obtain each edge point in the smoothed image, performing an area division of the smoothed image to obtain each area to be processed, confirming the quantity of edge points in each area to be processed, using the area to be processed with a quantity of edge points exceeding a predetermined quantity threshold as an area to be enhanced, and using the area to be processed with a quantity of edge points not exceeding the predetermined quantity threshold as another area;
a self-regulation enhancement device, coupled to the area division device, for executing a contrast enhancement process of an area to be enhanced to a corresponding magnitude based on the quantity of internal edge points to obtain an enhanced area, executing a contrast enhancement process of the other area to a corresponding magnitude to obtain another processed area, performing an integration process of each enhanced area and each other processed area to obtain a corresponding self-regulation enhanced image, and outputting the self-regulation enhanced image;
an authorization verification device, coupled to the self-regulation enhancement device, for receiving the self-regulation enhanced image, performing a characteristic matching of an image characteristic of the self-regulation enhanced image based on a predetermined authorized person's face characteristic, and issuing an authorized person existence signal if the characteristic matching has a percentage value exceeding a predetermined percentage threshold, or else issuing an authorized person non-existence signal; and
a motor driving device, coupled to the authorization verification device and the motor speed regulation device, for stopping the motor speed regulation device from responding to different operations thereof when the authorized person non-existence signal is received;
wherein, the motor driving device resumes the motor speed regulation device to respond to different operations thereof when the authorized person existence signal is received.

2. The axial-flow blow dryer based on motor speed regulation as claim in claim 1, wherein the multi-parameter analysis device, the coefficient fetching device and the binarization analysis device are implemented by using different SOC chips respectively.

3. The axial-flow blow dryer based on motor speed regulation as claim in claim 2, further comprising: a warning control device, coupled to the current capture device, for receiving the instant captured image, fetching each pixel value of each pixel point in the instant captured image, calculating a standard deviation based on each pixel value of each pixel point in the instant captured image, issuing a blocking warning signal when the standard deviation is over-limit, and issuing a non-blocking prompt signal when the standard deviation is not over-limit.

4. The axial-flow blow dryer based on motor speed regulation as claim in claim 3, further comprising a sub-image composition device, coupled to the warning control device, for fetching each brightness of each pixel point in the instant captured image when the blocking warning signal is received, using the pixel point with the brightness smaller than or equal to a predetermined brightness threshold as a blocked pixel point, eliminating an isolated blocked pixel point in the instant captured image, combining each non-isolated blocked pixel point in the instant captured image to form each blocking sub-image.

5. The axial-flow blow dryer based on motor speed regulation as claim in claim 4, further comprising an alarm control device, coupled to the sub-image composition device, for receiving each blocking sub-image in the instant captured image, calculating a quantity of pixel points occupied by each blocking sub-image as an area corresponding to the blocking sub-image, eliminating the blocking sub-image with an area smaller than or equal to a predetermined area threshold, accumulating each area of each remaining blocking sub-image to obtain a total blocking area, issuing a blocking alarm signal when the total blocking area is over-limit, and issuing an unconfirmed blocking signal when the total blocking area is not over-limit.

6. The axial-flow blow dryer based on motor speed regulation as claim in claim 5, further comprising a decision control device, coupled to the alarm control device, for starting a median filtering operation of the instant captured image when the unconfirmed blocking signal is received, substituting the filtered image by the instant captured image as an output, transmitting the blocking alarm signal to a remote management server via a wireless transmission when the blocking alarm signal is received.

7. The axial-flow blow dryer based on motor speed regulation as claim in claim 6, wherein the median filtering operation executed in the decision control device uses a filter window size directly proportional to the total blocking area.
